(19) United States
(12) Patent Application Publication
(10) Pub. No.: US 2014/0186612 A1
(43) Pub. Date: Jul. 3, 2014

(54) Transparent Thermoplastic Resin Composition and Molded Article Produced Therefrom

(71) Applicant: Cheil Industries Inc., Gumi-si (KR)

(72) Inventors: Young Chul KWON, Uiwang-si (KR); Kang Yeol PARK, Uiwang-si (KR); Yoen Kyoung KIM, Uiwang-si (KR); Dong Hyun PARK, Uiwang-si (KR); Seon Ae LEE, Uiwang-si (KR); Jin Seong LEE, Uiwang-si (KR)

(21) Appl. No.: 13/926,151

(22) Filed: Jun. 25, 2013

(30) Foreign Application Priority Data
Dec. 31, 2012 (KR) 10-2012-0158647

(51) Int. Cl. C08L 33/20

(52) U.S. Cl. CPC C08L 33/20
USPC 428/327; 525/70; 525/86; 524/504; 523/122

(57) ABSTRACT

A transparent thermoplastic resin composition includes (A) a rubber-modified vinyl-based copolymer; and (B) a cyanated vinyl-aromatic vinyl-based copolymer, wherein the (A) rubber-modified vinyl-based copolymer includes a rubbery polymer having an average particle size of about 500 Å to about 1,900 Å, the (B) cyanated vinyl-aromatic vinyl-based copolymer has a glass transition temperature of about 105° C. or less, and a difference in index of refraction between the (A) rubber-modified vinyl-based copolymer and the (B) cyanated vinyl-aromatic vinyl-based copolymer is about 0.01 or less. The transparent thermoplastic resin composition can have excellent properties in terms of scratch resistance, transparency, and/or impact resistance.

### CROSS-REFERENCE TO RELATED APPLICATION

This application claims priority under 35 USC Section 119 to and the benefit of Korean Patent Application 10-2012-0158647 filed on Dec. 31, 2012, the entire disclosure of which is incorporated herein by reference.

### FIELD OF THE INVENTION

The present invention relates to a transparent thermoplastic resin composition and a molded article produced therefrom.

### BACKGROUND OF THE INVENTION

Transparent resins such as styrene-acrylonitrile (SAN), polycarbonate (PC), polystyrene (GPPS), polymethyl methacrylate (PMMA) resins, and the like are generally used for products requiring transparency. Despite merits of excellent transparency and low price, these SAN, GPPS and PMMA resins can have insufficient impact resistance and thus have a limited application range. In addition, although PC resins can have excellent transparency and impact resistance, PC resins can have drawbacks, such as high price, insufficient scratch resistance, insufficient chemical resistance, and the like, thus limiting applications for the same.

Non-plated (or non-coated) resins which do not require post-processing can be used in housings and front covers of electronic home appliances such as TVs and monitors in order to solve problems such as environmental pollution, low productivity, and the like. Moreover, in order to provide pleasing appearances to articles, double-shot molded materials including both a colored side and transparent side have been developed together with a material consisting of transparent components (transparent resins).

As a transparent resin for housings of electronic home appliances, a transparent PC resin was initially used. However, since PC resins have drawbacks such as insufficient scratch resistance, high impact polymethyl methacrylate (HI-PMMA) with improved scratch resistance has been used. However, HI-PMMA is expensive, has low flowability, and can cause failure such as interface separation upon double-shot molding due to bonding between acrylonitrile-butadiene-styrene (ABS) copolymers, which are generally used as a colored side material, and other materials.

A transparent ABS resin has higher impact strength than SAN and PMMA, and a lower price than PC. In addition, upon double shot molding, the transparent ABS resin exhibits excellent bonding strength due to similar composition to the colored side material. Due to such merits, studies to develop transparent ABS materials are actively underway in the art. For the transparent ABS resin, an index of refraction of a matrix resin (SAN resin or the like) acting as a continuous phase must match an index of refraction of a rubber (g-ABS or the like) acting as a dispersed phase so as to minimize scattering and refraction of light at an interface between the continuous phase and the dispersed phase, whereby the ABS resin can exhibit transparency. Thus, in order to impart transparency to the ABS resin, the index of refraction of the rubber phase must be adjusted to match that of the matrix resin acting as the continuous phase while minimizing scattering of light in the visible light range through suitable adjustment of the particle size of the rubber.

However, transparent ABS resins in the related art still suffer insufficient properties in terms of scratch resistance, transparency, impact resistance and the like, thus limiting applicability thereof to housings of electronic home appliances, etc. Moreover, transparent ABS resins in the related art can exhibit cold whitening in thermal cycle evaluations (low temperature aging) of molded articles, and can cause failure such as occurrence of bubbles and the like due to cooling rates in the production of molded articles.

Therefore, there is a need for ABS-based transparent thermoplastic resin compositions, which can prevent failures such as cold whitening, bubbles, and the like, while improving scratch resistance, transparency, impact resistance, and the like.

### SUMMARY OF THE INVENTION

The present invention relates to a transparent thermoplastic resin composition, which can have excellent scratch resistance, transparency and/or impact resistance, can have a glass transition temperature of about 100° C. or less and can be suited for use as a transparent side of a double-shot molded material, and a molded article produced therefrom.

The transparent thermoplastic resin composition includes (A) a rubber-modified vinyl-based copolymer; and (B) a cyanated vinyl-aromatic vinyl-based copolymer, wherein the (A) rubber-modified vinyl-based copolymer includes a rubbery polymer having an average particle size of about 500 Å to about 1,900 Å, the (B) cyanated vinyl-aromatic vinyl-based copolymer has a glass transition temperature of about 105° C. or less, and a difference in index of refraction between the (A) rubber-modified vinyl-based copolymer and the (B) cyanated vinyl-aromatic vinyl-based copolymer is about 0.01 or less.

In one embodiment, the (A) rubber-modified vinyl-based copolymer and the (B) cyanated vinyl-aromatic vinyl-based copolymer may each independently have an index of refraction of about 1.51 to about 1.52.

In one embodiment, the (A) rubber-modified vinyl-based copolymer may be present in an amount of about 4% by weight (wt %) to about 14 wt %, and the (B) cyanated vinyl-aromatic vinyl-based copolymer may be present in an amount of about 86 wt % to about 96 wt %.

In one embodiment, the (A) rubber-modified vinyl-based copolymer may be obtained by grafting a monomer mixture of an aromatic vinyl monomer and a cyanated vinyl monomer to a rubbery polymer.

The monomer mixture may further include an alkyl(meth)acrylate monomer.

In one embodiment, the (B) cyanated vinyl-aromatic vinyl-based copolymer may be a copolymer of a monomer mixture including an aromatic vinyl monomer and a cyanated vinyl monomer.

The monomer mixture may further include an alkyl(meth)acrylate monomer.

In one embodiment, the (B) cyanated vinyl-aromatic vinyl-based copolymer may have a weight average molecular weight of about 80,000 g/mol to about 150,000 g/mol.

In one embodiment, the transparent thermoplastic resin composition may further include at least one of flame retardants, surfactants, nucleating agents, coupling agents, fillers, plasticizers, impact-reinforcing agents, lubricants, antibacterial agents, release agents, heat stabilizers, antioxidants, photostabilizers, compatibilizers, inorganic additives, antistatic agents, pigments, dyes, and the like, and combinations thereof.

In one embodiment, the transparent thermoplastic resin composition may have a glass transition temperature of about 90° C. to about 100° C.

In one embodiment, the transparent thermoplastic resin composition may have a haze of about 1.0% or less and an optical transmittance of about 88% or more as measured on a 2.5 mm thick specimen.

In one embodiment, the transparent thermoplastic resin composition may have a scratch width of about 220 μm to about 263 μm and pencil hardness rating of H to 2H according to ball type scratch profile testing.

In one embodiment, the transparent thermoplastic resin composition may have an Izod impact strength of about 20 kgf·cm/cm to about 35 kgf·cm/cm as measured on a ⅛″ thick specimen.

The present invention also relates to a molded article produced from the thermoplastic resin composition.

In one embodiment, the molded article may include a transparent side and a colored side, wherein the transparent side may be formed of the transparent thermoplastic resin composition.

### BRIEF DESCRIPTION OF THE DRAWINGS

FIG. 1 is a picture of a specimen produced from a transparent thermoplastic resin composition prepared in Comparative Example 3, showing occurrence of bubbles.

FIG. 2 shows a picture of specimens produced from transparent thermoplastic resin compositions prepared in Example 1 and Comparative Example 3 after low temperature whitening testing.

### DETAILED DESCRIPTION OF THE INVENTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

According to the present invention, a transparent thermoplastic resin composition includes (A) a rubber-modified vinyl-based copolymer; and (B) a cyanated vinyl-aromatic vinyl-based copolymer.

(A) Rubber-Modified Vinyl-Based Copolymer

The (A) rubber-modified vinyl-based copolymer of the invention is a copolymer with a core-shell structure wherein a rubbery polymer (core) has an average particle size (Z-average) of about 500 Å to about 1,900 Å, for example from about 700 Å to about 1,500 Å. In some embodiments, the rubbery polymer has an average particle size of about 500, 600, 700, 800, 900, 1000, 1100, 1200, 1300, 1400, 1500, 1600, 1700, 1800, or 1900 Å. Further, according to some embodiments of the present invention, the rubbery polymer can have an average particle size from about any of the foregoing sizes to about any other of the foregoing sizes.

If the average particle size of the rubbery polymer is less than about 500 Å, the thermoplastic resin composition containing the rubbery polymer can suffer from deterioration in impact resistance, and if the average particle size of the rubbery polymer exceeds about 1,900 Å, the thermoplastic resin composition can suffer from deterioration in scratch resistance and transparency.

The (A) rubber-modified vinyl-based copolymer may be obtained by grafting a monomer mixture including an aromatic vinyl monomer and a cyanated vinyl monomer to the rubbery polymer, and may further include an alkyl(meth)acrylate monomer and/or a monomer for imparting processibility and heat resistance, as needed.

Examples of the rubbery polymer include without limitation diene rubbers such as polybutadiene, poly(styrene-butadiene), poly(acrylonitrile-butadiene), and the like; saturated rubbers such as those obtained by adding hydrogen to the diene rubbers; isoprene rubbers; acrylic rubbers such as poly(butyl acrylate); ethylene-propylene-diene monomer (EPDM) terpolymers; and the like, and combinations thereof. Among these materials, the rubbery polymer can include a diene rubber, for example a butadiene rubber.

The rubber-modified vinyl-based copolymer may include the rubbery polymer in an amount of about 40 wt % to about 60 wt %, for example from about 45 wt % to about 60 wt %, based on the total weight of the (A) rubber-modified vinyl-based copolymer. In some embodiments, the rubber-modified vinyl-based copolymer may include the rubbery polymer in an amount of about 40, 41, 42, 43, 44, 45, 46, 47, 48, 49, 50, 51, 52, 53, 54, 55, 56, 57, 58, 59, or 60 wt %. Further, according to some embodiments of the present invention, the amount of the rubbery polymer can be in a range from about any of the foregoing amounts to about any other of the foregoing amounts.

Within this range, the composition can have a balance of excellent impact resistance and mechanical properties.

The aromatic vinyl monomer may be an aromatic vinyl monomer capable of being grafted to the rubbery copolymer. Examples of the aromatic vinyl monomer capable of being grafted to the rubbery copolymer may include without limitation styrene, α-methylstyrene, β-methylstyrene, p-methylstyrene, para-t-butylstyrene, ethylstyrene, vinyl xylene, monochlorostyrene, dichlorostyrene, dibromostyrene, and vinyl naphthalene. These may be used alone or in combination thereof. In exemplary embodiments, the aromatic vinyl monomer can include styrene.

The (A) rubber-modified vinyl-based copolymer may include the aromatic vinyl monomer in an amount of about 20 wt % to about 55 wt %, for example from about 20 wt % to about 50 wt %, based on the total weight of the (A) rubber-modified vinyl-based copolymer. In some embodiments, the (A) rubber-modified vinyl-based copolymer can include the aromatic vinyl monomer in an amount of about 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, or 55 wt %. Further, according to some embodiments of the present invention, the amount of the aromatic vinyl monomer can be in a range from about any of the foregoing amounts to about any other of the foregoing amounts.

Within this range, the composition can have a balance of excellent impact strength and mechanical properties.

Examples of the cyanated vinyl monomer may include without limitation acrylonitrile, methacrylonitrile, ethylacrylonitrile, and the like. These monomers may be used alone or in combination thereof.

The (A) rubber-modified vinyl-based copolymer may include the cyanated vinyl monomer in an amount of about 5 wt % to about 30 wt %, for example from about 4 wt % to about 28 wt %, based on the total weight of the (A) rubber-modified vinyl-based copolymer. In some embodiments, the (A) rubber-modified vinyl-based copolymer can include the cyanated vinyl monomer in an amount of about 5, 6, 7, 8, 9, 10, 11, 12, 13, 14, 15, 16, 17, 18, 19, 20, 21, 22, 23, 24, 25, 26, 27, 28, 29, or 30 wt %. Further, according to some embodiments of the present invention, the amount of the cyanated vinyl monomer can be in a range from about any of the foregoing amounts to about any other of the foregoing amounts.

Within this range, the composition can have a balance of excellent impact resistance and mechanical properties.

The alkyl(meth)acrylate monomer may be a C₁ to C₁₂ alkyl(meth)acrylate ester. Examples of the alkyl(meth)acrylate monomer may include without limitation alkyl(meth)acrylate esters such as methyl methacrylate, ethyl methacrylate, propyl methacrylate, butyl methacrylate, phenyl methacrylate, phenoxy ethyl methacrylate, benzyl methacrylate, and the like; and alkyl acrylate esters such as methyl acrylate, ethyl acrylate, propyl acrylate, butyl acrylate, 2-ethylhexyl acrylate, and the like. These may be used alone or in combination thereof. In exemplary embodiments, methyl methacrylate can be used.

The (A) rubber-modified vinyl-based copolymer may optionally include the alkyl(meth)acrylate monomer in an amount of about 35 wt % or less, for example about 30 wt % or less, based on the total weight of the (A) rubber-modified vinyl-based copolymer. In some embodiments, the (A) rubber-modified vinyl-based copolymer may include the alkyl(meth)acrylate monomer in an amount of 0 (the monomer is not present), about 0 (the monomer is present), 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, or 35 wt %. Further, according to some embodiments of the present invention, the amount of the alkyl(meth)acrylate monomer can be in a range from about any of the foregoing amounts to about any other of the foregoing amounts.

Within this range, the thermoplastic resin composition can secure excellent transparency and scratch resistance.

Examples of the monomer for imparting processability and heat resistance may include without limitation acrylic acid, methacrylic acid, maleic anhydride, N-substituted maleimide, and the like, and combinations thereof.

The (A) rubber-modified vinyl-based copolymer may include the monomer for imparting processability and heat resistance in an amount of about 15 wt % or less, for example from about 0.1 wt % to about 10 wt %, based on the total weight of the (A) rubber-modified vinyl-based copolymer. In some embodiments, the (A) rubber-modified vinyl-based copolymer may include the monomer for imparting processability and heat resistance in an amount of 0 (the monomer is not present), about 0 (the monomer is present), 0.1, 0.2, 0.3, 0.4, 0.5, 0.6, 0.7, 0.8, 0.9, 1, 2, 3, 4, 5, 6, 7, 8, 9, 10, 11, 12, 13, 14, or 15 wt %. Further, according to some embodiments of the present invention, the amount of the monomer for imparting processability and heat resistance can be in a range from about any of the foregoing amounts to about any other of the foregoing amounts.

Within this range, the monomer can impart processability and heat resistance to the thermoplastic resin composition without deterioration of other properties. Examples of the (A) rubber-modified vinyl-based copolymer may include without limitation acrylonitrile-butadiene-styrene graft copolymers (g-ABS), methyl methacrylate-acrylonitrile-butadiene-styrene graft copolymers (g-MABS), and the like, and combinations thereof. In exemplary embodiments, the rubber-modified vinyl-based copolymer can include g-MABS.

For example, the g-MABS can include polybutadiene (PBD) as a rubbery polymer core and a methyl methacrylate-acrylonitrile-butadiene-styrene copolymer shell grafted to the core, wherein the shell may include an inner shell consisting of acrylonitrile-styrene and an outer shell consisting of methyl methacrylate, without being limited thereto.

In this invention, the (A) rubber-modified vinyl-based copolymer may be prepared by a conventional method, in which a monomer mixture of the aromatic vinyl monomer, the cyanated vinyl monomer and, optionally, the alkyl(meth)acrylate monomer and the like, is grafted to a surface of the rubbery polymer. For example, to form an inner shell on the surface of the rubbery polymer, the aromatic vinyl monomer and the cyanated vinyl monomer can be grafted to the surface of the rubbery polymer and, as needed, the alkyl(meth)acrylate monomer or the like can be added thereto to form an outer shell surrounding the inner shell. Here, the inner shell may be polymerized using a fat-soluble redox initiator system, and the outer shell may be polymerized using a water-soluble initiator system. Then, the prepared (A) rubber-modified vinyl-based copolymer may be obtained in powder form through post-processes such as solidification, washing, and the like.

The thermoplastic resin composition may include the (A) rubber-modified vinyl-based copolymer in an amount of about 4 wt % to about 14 wt %, for example from about 5 wt % to about 13 wt %, based on the total weight of the thermoplastic resin composition. In some embodiments, the thermoplastic resin composition may include the (A) rubber-modified vinyl-based copolymer in an amount of about 4, 5, 6, 7, 8, 9, 10, 11, 12, 13, or 14 wt %. Further, according to some embodiments of the present invention, the amount of the (A) rubber-modified vinyl-based copolymer can be in a range from about any of the foregoing amounts to about any other of the foregoing amounts.

Within this range, the thermoplastic resin composition can exhibit excellent properties in terms of scratch resistance, transparency, impact resistance, and the like.

(B) Cyanated Vinyl-Aromatic Vinyl-Based Copolymer

In this invention, the (B) cyanated vinyl-aromatic vinyl-based copolymer has a glass transition temperature of about 105° C. or less, for example about 95° C. to about 105° C.

The (B) cyanated vinyl-aromatic vinyl-based copolymer may be prepared using the monomer mixture including the aromatic vinyl monomer, the cyanated vinyl monomer, and the like excluding the rubbery polymer among the components of the (A) rubber-modified vinyl-based copolymer by any typical polymerization process such as emulsion polymerization, suspension polymerization, solution polymerization, mass polymerization, and the like. The ratio of the monomer may vary according to compatibility.

If the glass transition temperature of the (B) cyanated vinyl-aromatic vinyl-based copolymer exceeds about 105° C., a molded article produced using the thermoplastic resin composition can suffer from low temperature whitening as determined through heat cycle evaluation, and bubbles can be generated in production of the molded article.

Examples of the aromatic vinyl monomer may include without limitation styrene, α-methylstyrene, β-methylstyrene, p-methylstyrene, p-t-butylstyrene, ethylstyrene, vinylxylene, monochlorostyrene, dichlorostyrene, dibromostyrene, vinyl naphthalene, and the like. These may be used alone or in combination thereof. In exemplary embodiments, the aromatic vinyl monomer can include styrene.

Examples of the cyanated vinyl monomer may include without limitation vinyl cyanide compounds such as acrylonitrile; unsaturated nitriles such as acrylonitrile, methacrylonitrile, ethylacrylonitrile, and the like. These may be used alone or in combination thereof.

The (B) cyanated vinyl-aromatic vinyl-based copolymer may further include an alkyl(meth)acrylate monomer and/or a monomer for imparting processibility and heat resistance, as needed.

The alkyl(meth)acrylate monomer may be a C₁ to C₁₂ alkyl(meth)acrylate ester. Examples of the alkyl(meth)acrylate monomer may include without limitation alkyl(meth)acrylate esters such as methyl methacrylate, ethyl methacrylate, propyl methacrylate, butyl methacrylate, phenyl methacrylate, phenoxy ethyl methacrylate, benzyl methacrylate, and the like; and alkyl acrylate esters such as methyl acrylate, ethyl acrylate, propyl acrylate, butyl acrylate, 2-ethylhexyl acrylate, and the like. These may be used alone or in combination thereof. In exemplary embodiments, methyl methacrylate can be used.

Examples of the monomer for imparting processability and heat resistance may include without limitation acrylic acid, methacrylic acid, maleic anhydride, N-substituted maleimide, and the like, and combinations thereof.

The (B) cyanated vinyl-aromatic vinyl-based copolymer may include the aromatic vinyl monomer in an amount of about 50 wt % to about 95 wt %, for example from about 55 wt % to about 90 wt %, based on the total weight of the (B) cyanated vinyl-aromatic vinyl-based copolymer. In some embodiments, the (B) cyanated vinyl-aromatic vinyl-based copolymer can include the aromatic vinyl monomer in an amount of about 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, or 95 wt %. Further, according to some embodiments of the present invention, the amount of the aromatic vinyl monomer can be in a range from about any of the foregoing amounts to about any other of the foregoing amounts.

Within this range, the thermoplastic resin composition can obtain a balance of excellent impact resistance and mechanical properties.

The (B) cyanated vinyl-aromatic vinyl-based copolymer may include the cyanated vinyl monomer in an amount of about 5 wt % to about 50 wt %, for example from about 10 wt % to about 45 wt %, based on the total weight of the (B) cyanated vinyl-aromatic vinyl-based copolymer. In some embodiments, the (B) cyanated vinyl-aromatic vinyl-based copolymer may include the cyanated vinyl monomer in an amount of about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 wt %. Further, according to some embodiments of the present invention, the amount of the cyanated vinyl monomer can be in a range from about any of the foregoing amounts to about any other of the foregoing amounts.

Within this range, the thermoplastic resin composition can obtain a balance of excellent impact resistance and mechanical properties.

The (B) cyanated vinyl-aromatic vinyl-based copolymer may optionally include the alkyl(meth)acrylate monomer in an amount of about 45 wt % or less, for example about 33 wt % or less, based on the total weight of the (B) cyanated vinyl-aromatic vinyl-based copolymer. In some embodiments, the (B) cyanated vinyl-aromatic vinyl-based copolymer may optionally include the alkyl(meth)acrylate monomer in an amount of 0 (the monomer is not present), about 0 (the monomer is present), 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, or 45 wt %. Further, according to some embodiments of the present invention, the amount of the alkyl(meth)acrylate monomer can be in a range from about any of the foregoing amounts to about any other of the foregoing amounts.

Within this range, the thermoplastic resin composition can secure excellent transparency and scratch resistance.

Further, the (B) cyanated vinyl-aromatic vinyl-based copolymer may optionally include the monomer for imparting processability and heat resistance in an amount of about 30 wt % or less, for example from about 0.1 wt % to about 20 wt %, based on the total weight of the (B) cyanated vinyl-aromatic vinyl-based copolymer. In some embodiments, the (B) cyanated vinyl-aromatic vinyl-based copolymer may include the monomer for imparting processability and heat resistance in an amount of 0 (the monomer is not present), about 0 (the monomer is present), 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 wt %. Further, according to some embodiments of the present invention, the amount of the monomer for imparting processability and heat resistance can be in a range from about any of the foregoing amounts to about any other of the foregoing amounts.

Within this range, the monomer can impart processability and heat resistance to the thermoplastic resin composition without deterioration of other properties.

The (B) cyanated vinyl-aromatic vinyl-based copolymer may have a weight average molecular weight of about 80,000 g/mol to about 150,000 g/mol, for example from about 90,000 g/mol to about 140,000 g/mol. Within this range, the thermoplastic resin composition can exhibit excellent impact resistance and flowability.

The thermoplastic resin composition may include the (B) cyanated vinyl-aromatic vinyl-based copolymer in an amount of about 86 wt % to about 96 wt %, for example from about 87 wt % to about 95 wt %, based on the total weight of the thermoplastic resin composition. In some embodiments, the thermoplastic resin composition may include the (B) cyanated vinyl-aromatic vinyl-based copolymer in an amount of about 86, 87, 88, 89, 90, 91, 92, 93, 94, 95, or 96 wt %. Further, according to some embodiments of the present invention, the amount of the (B) cyanated vinyl-aromatic vinyl-based copolymer can be in a range from about any of the foregoing amounts to about any other of the foregoing amounts.

Within this range, the thermoplastic resin composition can exhibit excellent properties in terms of scratch resistance, transparency, impact resistance, and the like.

Examples of the (B) cyanated vinyl-aromatic vinyl-based copolymer may include without limitation a styrene-acrylonitrile copolymer (SAN), a methyl methacrylate-styrene-acrylonitrile copolymer (MSAN), and the like, and combinations thereof, which can be prepared under the aforementioned conditions. In exemplary embodiments, the (B) cyanated vinyl-aromatic vinyl-based copolymer can include MSAN.

In the transparent thermoplastic resin composition, the (A) rubber-modified vinyl-based copolymer may be present in a dispersed state in a matrix (continuous phase) including the (B) cyanated vinyl-aromatic vinyl-based copolymer. For example, the (A) rubber-modified vinyl-based copolymer may be an acrylonitrile-butadiene-styrene copolymer resin (ABS resin), in which a graft copolymer (g-ABS) obtained by grafting a monomer mixture of a styrene monomer, which is an aromatic vinyl compound, and an acrylonitrile monomer, which is a cyanated vinyl compound, to a core of a butadiene rubber polymer, is dispersed in a styrene-acrylonitrile copolymer (SAN) as the (B) cyanated vinyl-aromatic vinyl-based copolymer. In addition to the ABS resin, other examples of the (A) rubber-modified vinyl-based copolymer may include without limitation a methyl methacrylate-acrylonitrile-butadiene-styrene copolymer (MABS) resin, an acrylonitrile-ethylene/propylene rubber-styrene copolymer (AES) resin, an acrylonitrile-styrene-acryl rubber copolymer (ASA) resin, and the like, and combinations thereof.

In one embodiment, a difference in index of refraction between the (A) rubber-modified vinyl-based copolymer and the (B) cyanated vinyl-aromatic vinyl-based copolymer is about 0.01 or less, for example about 0 to about 0.006. Within this range, the transparent thermoplastic resin composition can exhibit excellent transparency.

Further, the rubber modified vinyl-based graft copolymer (A) and the (B) cyanated vinyl-aromatic vinyl-based copolymer may each independently have an index of refraction ranging from about 1.51 to about 1.52, for example from about 1.512 to about 1.518. Within this range, the transparent thermoplastic resin composition can exhibit excellent transparency.

The transparent thermoplastic resin composition may further include one or more additives. Examples of the additives can include without limitation flame retardants, surfactants, nucleating agents, coupling agents, fillers, plasticizers, impact-reinforcing agents, lubricants, antibacterial agents, release agents, heat stabilizers, antioxidants, photostabilizers, compatibilizers, inorganic additives, antistatic agents, pigments, dyes, and the like, as needed. These additives may be used alone or in combination thereof. The additives may be present in an amount of about 0.001 parts by weight to about 20 parts by weight based on about 100 parts by weight of the thermoplastic resin composition, without being limited thereto.

The transparent thermoplastic resin composition according to this invention may have a glass transition temperature of about 90° C. to about 100° C., for example from about 92° C. to about 98° C. Within this range, the thermoplastic resin composition can prevent low temperature whitening and occurrence of bubbles.

The transparent thermoplastic resin composition may have a haze of about 1.0% or less, for example about 0.8% or less, and an optical transmittance of about 88% or more, for example about 89% or more, as measured on a 2.5 mm thick specimen in accordance with ASTM D1003.

The transparent thermoplastic resin composition may have a scratch width of about 220 μm to about 263 μm and pencil hardness rating of H to 2H according to ball type scratch profile testing.

Further, the transparent thermoplastic resin composition may have an Izod impact strength of about 20 kgf·cm/cm to about 35 kgf·cm/cm, for example about 22 kgf·cm/cm to about 33 kgf·cm/cm, as measured on a ⅛″ thick specimen.

Within these physical property ranges, the transparent thermoplastic resin composition can exhibit transparent textures in a large molded article such as 32 inch or wider TV housings and excellent properties in terms of scratch resistance, impact resistance, and the like, so as to be applicable for use in exterior materials for electronic products, automobiles, miscellaneous goods, and the like.

The transparent thermoplastic resin composition according to the invention may be prepared by any method for preparing a thermoplastic resin composition known in the art. For example, the transparent thermoplastic resin composition may be prepared in the form of pellets by mixing the above components and other additives, followed by melt extrusion in an extruder. Then, various molded articles may be produced using the prepared pellets through plastic injection molding, compression, and the like.

A molded article according to the invention may be produced by any molding method, such as extrusion, injection, hollow molding, compression, casting, and the like, without being limited thereto. The molding method is broadly known to a person having ordinary knowledge in the art. The molded article may be used for various purposes, for example, housings of electronic home appliances, such as TVs and the like. Particularly, when the molded article is formed through double shot molding and includes a colored side and a transparent side, adhesion to an ABS resin generally used as a material for the colored side can be improved, which can prevent debonding at an interface between the materials in production of the molded article.

Now, the present invention will be described in more detail with reference to some examples. However, it should be noted that these examples are provided for illustration only and are not to be construed in any way as limiting the present invention.

### EXAMPLES

Details of each component used in the following examples and comparative examples were as follows:

(A) Rubber-Modified Vinyl-Based Copolymer

(A-1) g-MABS A: A methyl methacrylate-acrylonitrile-butadiene-styrene graft copolymer (g-MABS, Cheil Industries Inc.) comprising a rubbery polymer (core) which has an average particle size of 1,100 Å to 1,500 Å and an index of refraction of 1.515 as measured using a prism coupler is used.

(A-2) g-MABS B: A methyl methacrylate-acrylonitrile-butadiene-styrene graft copolymer (g-MABS, Cheil Industries Inc.) comprising a rubbery polymer (core) which has an average particle size of 2,000 Å to 3,000 Å and an index of refraction of 1.515 as measured using a prism coupler is used.

(A-3) g-MABS C: A methyl methacrylate-acrylonitrile-butadiene-styrene graft copolymer (g-MABS, Cheil Industries Inc.) comprising a rubbery polymer (core) which has an average particle size of 1,100 Å to 1,500 Å and an index of refraction of 1.528 as measured using a prism coupler is used.

(B) Cyanated Vinyl-Aromatic Vinyl-Based Copolymer

(B-1) MSAN A: A methyl methacrylate-styrene-acrylonitrile copolymer (MSAN, Cheil Industries Inc.) having a glass transition temperature (Tg) of 103° C. as measured according to DSC and an index of refraction of 1.515 as measured using a prism coupler is used.

(B-2) MSAN B: A methyl methacrylate-styrene-acrylonitrile copolymer (MSAN, Cheil Industries Inc.) having a glass transition temperature (Tg) of 110° C. as measured by DSC and an index of refraction of 1.515 as measured using a prism coupler is used.

### Examples 1 to 5 and Comparative Examples 1 to 5

Transparent thermoplastic resin compositions are prepared in pellet form through melt extrusion of a mixture obtained by mixing the components in amounts as listed in Table 1. Extrusion is carried out at 250° C. using a twin-screw extruder (L/D=36/1) having a diameter of 45 mm. The prepared pellets are dried at 100° C. for 4 hours, followed by injection molding using a 6 Oz injector to prepare specimens. The prepared specimens are evaluated as to physical properties by the following methods, and results are shown in Table 1.

Evaluation of Properties

(1) Transparency (optical property): Transmittance (total light transmittance (TT), unit: %) and haze (unit: %) are evaluated on a 2.5 mm thick injection-molded specimen. To evaluate transparency of the specimen, a total light transmittance value and a haze value are measured using a haze meter model NDH 2000 (Nippon Denshoku). Here, the total light transmittance is calculated as the total intensity of diffuse light transmittance factor (DF) and parallel transmittance, and the haze value is calculated by Equation 1:

Haze (%)={Diffuse light transmittance (DF)/parallel transmittance (PT)}×100.

Here, higher total light transmittance (TT) and lower haze are evaluated as higher transparency of the specimen.

(2) Pencil hardness: In accordance with ASTM D3362, pencil hardness is measured under a load of 500 g. Higher hardness and lower blackness are evaluated as higher scratch resistance.

(3) Scratch resistance (unit: μm): Scratch resistance is measured by Ball-type Scratch Profile (BSP) testing. A 10 to 20 mm long scratch is applied to a surface of a molded article specimen under a load of 1000 g at a speed of 75 mm/min using a spherical metal (tungsten carbide) tip having a diameter of 0.7 mm, and a profile of the applied scratch is measured by surface scanning using a tip of a metal stylus having a diameter of 2 μm through a contact type surface profile analyzer XP-1. From the measured scratch profile, scratch width (unit: μm) is obtained to determine scratch resistance. Here, a smaller scratch width is evaluated as higher scratch resistance.

(4) Glass transition temperature (Tg, unit: ° C.): Glass transition temperature is measured using a differential scanning calorimeter (DSC) by heating a specimen from 25° C. to 200° C. at a temperature increasing rate of 10° C./min.

(5) Izod impact strength (unit: kgf·cm/cm): Izod impact strength is measured on a ⅛″ Izod specimen in accordance with ASTM D256. (unit: kgf·cm/cm)

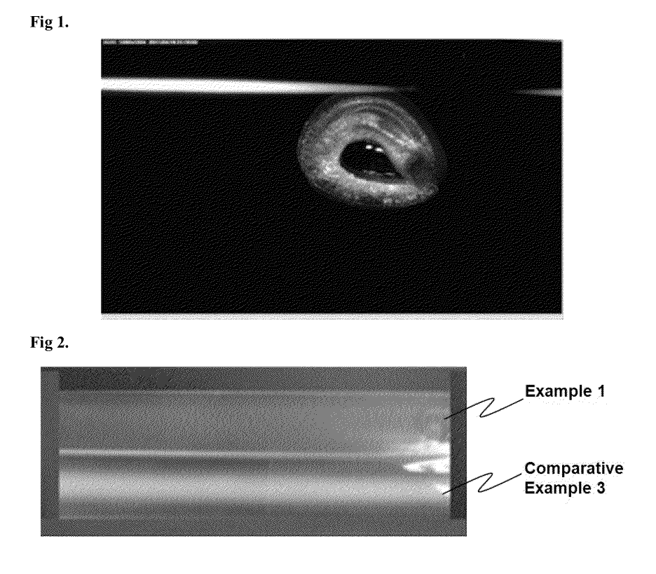

(6) Bubble occurrence: The number of bubbles is measured when preparing a transparent article in a 20 inch monitor housing mold through a 220 ton electric injector. After performing a total of 20 shots, an average value of 18 specimens excluding maximum and minimum values is obtained. FIG. 1 is a picture of a specimen produced from a transparent thermoplastic resin composition prepared in Comparative Example 3, showing occurrence of bubbles.

(7) Low temperature whitening: A 3 to 4 mm thick specimen having a size of 10 mm×10 mm is left in a chamber at −30° C. for 12 hours, followed by observation of an outer appearance of the specimen. FIG. 2 shows pictures of specimens produced from transparent thermoplastic resin compositions prepared in Example 1 and Comparative Example 3 after low temperature whitening testing.

TABLE 1
(Unit: wt %)

| | Example | | | | | Comparative Example | | |
|---|---|---|---|---|---|---|---|---|
| | 1 | 2 | 3 | 4 | 5 | 1 | 2 | 3 |
| g-MABS A | 5 | 7 | 9 | 11 | 13 | — | — | 11 |
| g-MABS B | — | — | — | — | — | 11 | — | — |
| g-MABS C | — | — | — | — | — | — | 11 | — |
| MSAN A | 95 | 93 | 91 | 89 | 87 | 89 | 89 | — |
| MSAN B | — | — | — | — | — | — | — | 89 |
| Transmit- | 91 | 90 | 90 | 90 | 90 | 85 | 75 | 90 |
| tance (%) | | | | | | | | |
| Haze (%) | 0.5 | 0.5 | 0.6 | 0.7 | 0.8 | 1.5 | 35 | 0.7 |
| Pencil | 2H | 2H | 2H | 2H | H | F | H | 2H |
| hardness | | | | | | | | |
| BSP (μm) | 230 | 235 | 240 | 250 | 255 | 267 | 250 | 250 |
| Tg (° C.) | 100 | 99 | 97 | 95 | 94 | 95 | 96 | 102 |
| Izod impact | 22 | 25 | 28 | 30 | 33 | 35 | 30 | 30 |
| resistance | | | | | | | | |
| (kgf · cm/ | | | | | | | | |
| cm) | | | | | | | | |
| Bubble | 8 | 5 | 2 | 0 | 0 | 8 | 9 | 15 |
| occurrence | | | | | | | | |
| (Number) | | | | | | | | |
| Low | No | No | No | No | No | No | No | Oc- |
| temperature | | | | | | | | curred |
| whitening | | | | | | | | |

From the results shown in Table 1, it can be seen that the transparent thermoplastic resin compositions according to the invention (Example 1 to 5) have excellent transparency from a transmittance of 90% or more and a haze of 0.8% or less, and excellent scratch resistance from pencil hardness rating of H or higher and a scratch width of 255 μm or less according to BSP testing. Further, the transparent thermoplastic resin compositions have an Izod impact resistance of 22 kgf·cm/cm or more, which represents excellent impact resistance, and a glass transition temperature of 100° C. or less, thereby preventing m occurrence of bubbles and low temperature whitening.

In contrast, in Comparative Example 1 wherein the (A) rubber-modified vinyl-based copolymer has an average particle size exceeding 1,900 Å, the transparent thermoplastic resin composition underwent deterioration in transparency and scratch resistance, despite good impact resistance. In Comparative Example 2 wherein a difference in index of refraction between the (A) rubber-modified vinyl-based copolymer and the (B) cyanated vinyl-aromatic vinyl-based copolymer exceeds 0.01, the composition underwent rapid deterioration in transparency. Moreover, in Comparative Example 3 wherein the (B) cyanated vinyl-aromatic vinyl-based copolymer has a glass transition temperature exceeding 105° C., the composition underwent severe occurrence of bubbles and low temperature whitening.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A transparent thermoplastic resin composition comprising:
(A) a rubber-modified vinyl-based copolymer; and
(B) a cyanated vinyl-aromatic vinyl-based copolymer,
wherein the (A) rubber-modified vinyl-based copolymer comprises a rubbery polymer having an average particle size of about 500 Å to about 1,900 Å, the (B) cyanated vinyl-aromatic vinyl-based copolymer has a glass transition temperature of about 105° C. or less, and a difference in index of refraction between the (A) rubber-modified vinyl-based copolymer and the (B) cyanated vinyl-aromatic vinyl-based copolymer is about 0.01 or less.

2. The transparent thermoplastic resin composition according to claim 1, wherein the (A) rubber-modified vinyl-based copolymer and the (B) cyanated vinyl-aromatic vinyl-based copolymer each independently have an index of refraction of about 1.51 to about 1.52.

3. The transparent thermoplastic resin composition according to claim 1, comprising the (A) rubber-modified vinyl-based copolymer in an amount of about 4 wt % to about 14 wt %, and the (B) cyanated vinyl-aromatic vinyl-based copolymer in an amount of about 86 wt % to about 96 wt %.

4. The transparent thermoplastic resin composition according to claim 1, wherein the (A) rubber-modified vinyl-based copolymer is obtained by grafting a monomer mixture comprising an aromatic vinyl monomer and a cyanated vinyl monomer to the rubbery polymer.

5. The transparent thermoplastic resin composition according to claim 4, wherein the monomer mixture further comprises an alkyl(meth)acrylate monomer.

6. The transparent thermoplastic resin composition according to claim 1, wherein the (B) cyanated vinyl-aromatic vinyl-based copolymer is a copolymer of a monomer mixture comprising an aromatic vinyl monomer and a cyanated vinyl monomer.

7. The transparent thermoplastic resin composition according to claim 6, wherein the monomer mixture further comprises an alkyl(meth)acrylate monomer.

8. The transparent thermoplastic resin composition according to claim 1, wherein the (B) cyanated vinyl-aromatic vinyl-based copolymer has a weight average molecular weight of about 80,000 g/mol to about 150,000 g/mol.

9. The transparent thermoplastic resin composition according to claim 1, further comprising at least one additive selected from the group consisting of flame retardants, surfactants, nucleating agents, coupling agents, fillers, plasticizers, impact-reinforcing agents, lubricants, antibacterial agents, release agents, heat stabilizers, antioxidants, photostabilizers, compatibilizers, inorganic additives, antistatic agents, pigments, dyes, and combinations thereof.

10. The transparent thermoplastic resin composition according to claim 1, wherein the transparent thermoplastic resin composition has a glass transition temperature of about 90° C. to about 100° C.

11. The transparent thermoplastic resin composition according to claim 1, wherein the transparent thermoplastic resin composition has a haze of about 1.0% or less and an optical transmittance of about 88% or more as measured on a 2.5 mm thick specimen.

12. The transparent thermoplastic resin composition according to claim 1, wherein the transparent thermoplastic resin composition has a scratch width of about 220 μm to about 263 μm and a pencil hardness of H to 2H according to ball type scratch profile testing.

13. The transparent thermoplastic resin composition according to claim 1, wherein the transparent thermoplastic resin composition has an Izod impact strength of about 20 kg·cm/cm to about 35 kg·cm/cm as measured on a ⅛″ thick specimen.

14. A molded article produced from the thermoplastic resin composition according to claim 1.

15. The molded article according to claim 14, wherein the molded article comprises a transparent side and a colored side, the transparent side being formed of the transparent thermoplastic resin composition.
